(19) United States
(12) Patent Application Publication
(10) Pub. No.: US 2015/0202855 A1
(43) Pub. Date: Jul. 23, 2015

(54) Paint sample sheet

(71) Applicants: Bonnie S. Larson, Marietta, GA (US); Robert J. Larson, Marietta, GA (US)

(72) Inventors: Bonnie S. Larson, Marietta, GA (US); Robert J. Larson, Marietta, GA (US)

(21) Appl. No.: 14/600,272

(22) Filed: Jan. 20, 2015

Related U.S. Application Data
(60) Provisional application No. 61/929,205, filed on Jan. 20, 2014.

(51) Int. Cl. B32B 37/24; C09J 7/02

(52) U.S. Cl. CPC B32B 37/24; C09J 7/026; C09J 2201/122; C09J 2201/28; B32B 2037/243

(57) ABSTRACT

A paint sample sheet is provided in several sizes, from an eighteen-inch square to a panel two feet wide and eight feet long, with a peel-and-stick backing or adhesive strips. The user may peel off the backing, hang the sheet on the wall, and then place various items of decor next to it, to determine whether the color will look good with the existing decor, and under various lighting conditions. The nature of the adhesive strips enables the user to reposition the sheet on various walls. Packages of multiple sheets in an array of complementary colors may be provided together as a set.

### CROSS-REFERENCE TO RELATED APPLICATIONS

This Application claims the benefit of U.S. Provisional Application No. 61/929205, filed Jan. 20, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to painting supplies and accessories, and in particular to a paint sample sheet. Painting the interior of a home or office can be a substantial investment, particularly for those who demand a professional quality paint job. The colors chosen must accurately match or coordinate with such color factors as those found on furniture, book bindings, draperies, artwork, bedspreads, and other items which would be difficult to carry into a paint store for matching. The usual approach to the matching process has been to provide four coordinated paint colors on a card, and the customer may take one or more cards back to the home or office and compare them with the existing decor. Unfortunately, such cards fail to clearly show how the paint will look on the wall because the sample is so small. When preparing for an expensive paint job and contemplating the color selection, most customers would welcome the opportunity to pay a nominal price to see how the paint will look on the wall, before investing in the paint itself. A paint sample sheet, featuring a large surface area and a peel-and-stick backing, would satisfy this demand.

### SUMMARY OF THE INVENTION

Accordingly, the invention is directed to a paint sample sheet. The sheet is provided in several sizes, from an eighteen-inch square to a panel two feet wide and eight feet long, with a peel-and-stick backing or adhesive strips. The user may peel off the backing, hang the sheet on the wall, and then place various items of decor next to it, to determine whether the color will look good with the existing decor, and under various lighting conditions. The nature of the adhesive strips enables the user to reposition the sheet on various walls. The user may also carry the sheet to various stores, such as furniture stores, and compare the color on the sheet to desired items for purchase. Packages of multiple sheets in an array of complementary colors may be provided together as a set.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrates two embodiments of the invention and, together with the description, serve to explain the principles of the invention.

FIG. 1 is a front view of the first exemplary embodiment, displaying the sheet 10, the seams 11, and the front surface 100.

FIG. 2 is a rear view of the first exemplary embodiment, displaying the sheet 10, the seams 11, the adhesive strips 12, and the rear surface 101.

FIG. 3 is a front view of a color assortment package of the second exemplary embodiment, displaying the sheets 10.

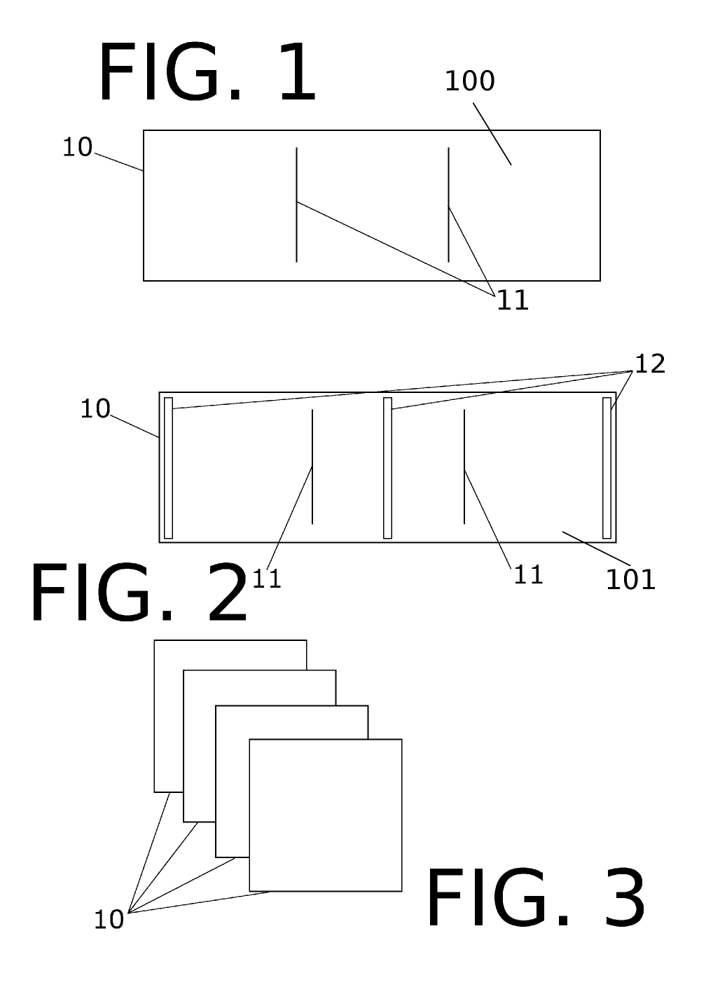

### DETAILED DESCRIPTION OF THE INVENTION

Referring now to the invention in more detail, the invention is directed to a paint sample sheet 10. The sheet 10 has applied to the front surface 100 a paint, such as wall paint, in a sample color. The sheet 10 is provided in several sizes, from an eighteen-inch square to a panel two feet wide and eight feet long, with a peel-and-stick backing or adhesive strips 12. The user may peel off the backing, hang the sheet 10 on the wall, and then place various items of decor next to it, to determine whether the color will look good with the existing decor, and under various lighting conditions. The nature of the adhesive strips 12 enables the user to reposition the sheet 10 on various walls. The user may also carry the sheet 10 to various stores, such as furniture stores, and compare the color on the sheet 10 to desired items for purchase. Packages of multiple sheets 10 in complementary colors may be provided together as a set.

The first exemplary embodiment features a rectangular sheet 10, which is preferably eighteen inches wide and fifty-four inches long. The sheet 10 is preferably letter-folded or accordion-folded for ease of packaging and transport, with two seams 11 separating the sheet 10 into three panels of approximately equal size. The sheet 10 may be perforated along the seams 11 to enable the user to neatly tear the sheet 10 into smaller panels as desired.

The second exemplary embodiment features a sheet 10 which is preferably eighteen inches square, and provided in a package of four sheets 10. Each of the sheets 10 in the package features one of four coordinated colors.

For both the first and second exemplary embodiments, on the rear surface 101 are three peel-and-stick adhesive strips 12. Alternately, the entire rear surface 101 of the sheet 10 may be a peel-and-stick adhesive area. Generically, and in the claims, an “adhesive area” may refer to an entire rear surface 101 or any smaller area, such as the adhesive strips 12, and the rear surface 101 of the sheet 10 preferably has at least one adhesive area affixed thereto. Other alternate embodiments, which feature other configurations for the adhesive backing, are also contemplated.

To use the first or the second exemplary embodiment, the user peels the paper backing from the peel-and-stick adhesive strips 12 or adhesive area, and adheres the sheet 10 to the wall. The user may reposition the sheet 10 on the wall, move it to a different wall, change the lighting conditions, and move furniture, draperies, and other items of decor next to the sheet 10 as desired.

The sheet 10 is preferably manufactured from a flexible, durable material such as paper, cardstock, or acetate, featuring a peel-and-stick backing. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A paint sample sheet comprising a sheet of material; said sheet of material having a front surface and a rear surface; a paint; said paint being in a sample color; said paint being applied to said front surface of said sheet of material; at least one adhesive area; said at least one adhesive area being affixed to said rear surface of said sheet of material.

2. The paint sample sheet of claim 1 wherein said at least one adhesive area comprises a single adhesive area; said single adhesive area covering said rear surface substantially entirely.

3. The paint sample sheet of claim 1 wherein said at least one adhesive area comprises a plurality of adhesive strips.

4. The paint sample sheet of claim 1 wherein said sheet of material is folded along a plurality of seams.

5. The paint sample sheet of claim 4 wherein each of said plurality of seams is perforated.

6. The paint sample sheet of claim 1 wherein said sheet of material measures about eighteen inches square.

7. The paint sample sheet of claim 1 wherein said sheet of material measures about eight feet by two feet.

8. The paint sample sheet of claim 1 wherein said sheet of material measures about eighteen inches by fifty-four inches.

9. A method comprising:
(a) providing at least one sample sheet; said at least one sample sheet comprising a sheet of material; said sheet of material having a front surface and a rear surface; a paint; said paint being in a sample color; said paint being applied to said front surface of said sheet of material; at least one adhesive area; said at least one adhesive area being affixed to said rear surface of said sheet of material;
(b) affixing said at least one sample sheet to a wall; and using said at least one adhesive area;
(c) observing the aesthetics of said sample sheet on said walls against varying configurations of any of the group of lighting, decor, draperies, and furniture.

10. The method of claim 9 further comprising taking said at least one sample sheet to store and observing the aesthetics of said at least one paint sample sheet against items in said store.

11. The method of claim 9 wherein providing said at least one sample sheet is at least two in number, and wherein each of said sample color of each of said at least one sample sheet is coordinated with those of the others of said at least one sample sheet.

12. The method of claim 11 wherein providing said at least one sample sheet is at least two in number, and wherein each of said sample color of each of said at least one sample sheet is coordinated with those of the others of said at least one sample sheet.

13. The paint sample sheet of claim 4 wherein said at least one adhesive area comprises a single adhesive area; said single adhesive area covering said rear surface substantially entirely.

14. The paint sample sheet of claim 4 wherein said at least one adhesive area comprises a plurality of adhesive strips.

15. The paint sample sheet of claim 5 wherein said at least one adhesive area comprises a single adhesive area; said single adhesive area covering said rear surface substantially entirely.

16. The paint sample sheet of claim 5 wherein said at least one adhesive area comprises a plurality of adhesive strips.

17. The paint sample sheet of claim 9 wherein said at least one adhesive area comprises a single adhesive area; said single adhesive area covering said rear surface substantially entirely.

18. The paint sample sheet of claim 9 wherein said at least one adhesive area comprises a plurality of adhesive strips.

19. The paint sample sheet of claim 9 wherein said sheet of material is folded along a plurality of seams.

20. The paint sample sheet of claim 19 wherein each of said plurality of seams is perforated.
